(19) United States
(12) Patent Application Publication
(10) Pub. No.: US 2025/0078330 A1
(43) Pub. Date: Mar. 6, 2025

(54) METHOD FOR PROCESSING COMMENTS AND ELECTRONIC DEVICE

(71) Applicant: BEIJING DAJIA INTERNET INFORMATION TECHNOLOGY CO., LTD., Beijing (CN)

(72) Inventors: Qiu YANG, Beijing (CN); Yanhang JIN, Beijing (CN); Ge SONG, Beijing (CN); Yayun ZUO, Beijing (CN); Shikun CHEN, Beijing (CN); Zhenkai YANG, Beijing (CN); Lu ZHANG, Beijing (CN); Bozhong HUANG, Beijing (CN); Huichen YANG, Beijing (CN); Chen QIU, Beijing (CN); Senhua CHEN, Beijing (CN); Nan GAO, Beijing (CN)

(21) Appl. No.: 18/643,963

(22) Filed: Apr. 23, 2024

(30) Foreign Application Priority Data
Sep. 5, 2023 (CN) 202311140973.0

(51) Int. Cl. G06T 11/00; G06Q 50/00; G06T 3/40

(52) U.S. Cl. CPC G06T 11/00; G06Q 50/01; G06T 3/40

(57) ABSTRACT

Disclosed is a method for processing comments. A post-operation region corresponding to a current resource is displayed, wherein the post-operation region is configured to post comment information and includes an image generation component. An image set is displayed in the post-operation region in response to triggering the image generation component in the case that the post-operation region includes source comment information, wherein the image set is generated based on the source comment information.

### CROSS-REFERENCE TO RELATED APPLICATIONS

This application is based on and claims priority to Chinese Patent Application No. 202311140973.0, filed on Sep. 5, 2023, the disclosure of which is herein incorporated by reference in its entirety.

### TECHNICAL FIELD

The present disclosure relates to the field of Internet technologies, and in particular, to a method for processing comments and an electronic device.

### BACKGROUND

With the rapid development of mobile Internet, terminal-based information dissemination has become increasingly mature. Generally, information can be embedded in various websites or applications in the terminal for dissemination.

### SUMMARY

The present disclosure provides a method for processing comments and an electronic device. The technical solutions of the present disclosure are as follows:

According to some embodiments of the present disclosure, a method for processing comments is provided, and the method includes the following steps.

A post-operation region corresponding to a current resource is displayed, wherein the post-operation region is configured to post comment information and includes an image generation component; and

An image set is displayed in the post-operation region in response to triggering the image generation component in the case that the post-operation region includes source comment information, wherein the image set is generated based on the source comment information.

According to some embodiments of the present disclosure, an electronic device is provided. The electronic device includes a processor and a memory configured to store instructions executable by the processor, wherein the processor, when loading and running the instructions, is caused to perform:
displaying a post-operation region corresponding to a current resource, wherein the post-operation region is configured to post comment information and includes an image generation component; and
displaying an image set in the post-operation region in response to triggering the image generation component in the case that the post-operation region includes source comment information, wherein the image set is generated based on the source comment information.

According to some embodiments of the present disclosure, a non-transitory computer-readable storage medium is provided. Wherein instructions in the non-transitory computer-readable storage medium, when executed by a processor of an electronic device, cause the electronic device to perform:
displaying a post-operation region corresponding to a current resource, wherein the post-operation region is configured to post comment information and includes an image generation component; and
displaying an image set in the post-operation region in response to triggering the image generation component in the case that the post-operation region includes source comment information, wherein the image set is generated based on the source comment information.

### BRIEF DESCRIPTION OF DRAWINGS

FIG. 1 is a schematic diagram of an application environment of a method for processing comments according to some embodiments of the present disclosure;

FIG. 2 is a flowchart of a method for processing comments according to some embodiments of the present disclosure;

FIG. 3 is a schematic diagram 1 of a page on an electronic device according to some embodiments of the present disclosure;

FIG. 4 is a schematic diagram 2 of a page on an electronic device according to some embodiments of the present disclosure;

FIG. 5 is a flowchart of a method for processing comments according to some embodiments of the present disclosure;

FIG. 6 is a schematic diagram 1 of source comment information according to some embodiments of the present disclosure;

FIG. 7 is a schematic diagram 2 of source comment information according to some embodiments of the present disclosure;

FIG. 8 is a schematic diagram 3 of source comment information according to some embodiments of the present disclosure;

FIG. 9 is a schematic diagram 4 of source comment information according to some embodiments of the present disclosure;

FIG. 10 is a schematic diagram 5 of source comment information according to some embodiments of the present disclosure;

FIG. 11 is a schematic diagram of adding a target image according to some embodiments of the present disclosure;

FIG. 12 is a schematic diagram of a comment display page according to some embodiments of the present disclosure;

FIG. 13 is a schematic diagram of an application page according to some embodiments of the present disclosure;

FIG. 14 is a schematic diagram of an image page according to some embodiments of the present disclosure;

FIG. 15 is a schematic diagram of an input page according to some embodiments of the present disclosure;

FIG. 16 is a block diagram of an apparatus for processing comments according to some embodiments of the present disclosure; and

FIG. 17 is a block diagram of an electronic device for processing comments according to some embodiments of the present disclosure.

### DETAILED DESCRIPTION

When viewing videos or images on a website or application, users may post comments on the videos or images. Typically, comments reflect the viewers' opinions on the videos or images and serve as a means to share information with other viewers. As the volume of content increases, users expect comments to provide more capabilities so as to increase the efficiency of information sharing, conserve computing resources, and improve platform service efficiency.

According to the embodiments of the present disclosure, an image generation component is triggered to display an image set based on source comment information, which enriches the interactive experience for users in the comment section, thereby expanding the scope of comment interaction without interrupting the user's commenting process.

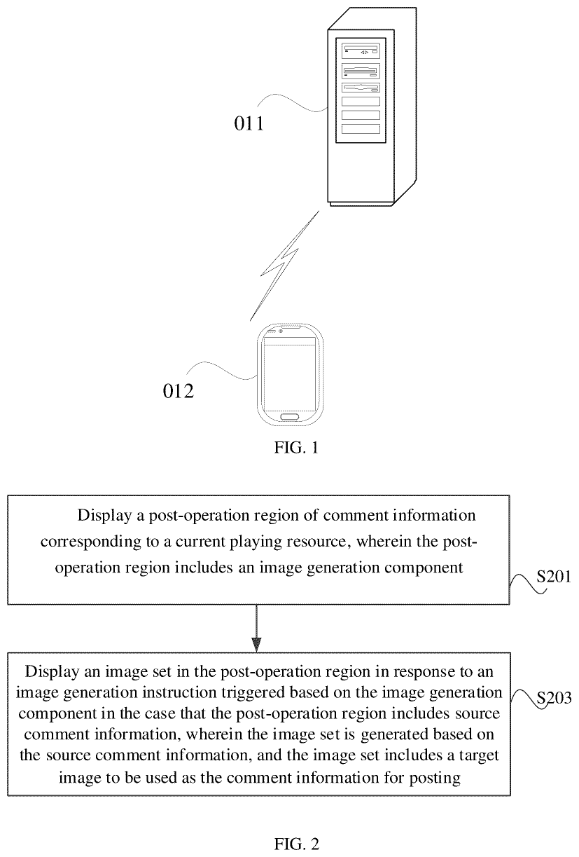

Referring to FIG. 1, FIG. 1 is a schematic diagram of an application environment of a method for processing comments according to some embodiments of the present disclosure. As shown in FIG. 1, the application environment includes a server 011 and an electronic device 012.

In some embodiments, the server 011 is an independent physical server, a server cluster or a distributed system composed of a plurality of physical servers, or a cloud server providing basic cloud computing services, such as a cloud service, a cloud database, cloud computing, a cloud function, cloud storage, a network service, cloud communication, a middleware service, a domain name service, a security service, a content delivery network (CDN), and big data and artificial intelligence platforms. Operating systems running on the server include but are not limited to Android, iOS, Linux, windows, and Unix.

In some embodiments, the electronic device 012 includes but is not limited to a smart phone, a desktop computer, a tablet computer, a notebook computer, a smart speaker, a digital assistant, an Augmented Reality (AR)/Virtual Reality (VR) device, and a smart wearable device. The electronic device 012 can run software, such as applications and applets. In some embodiments, operating systems running on the electronic device 012 include but are not limited to Android, iOS, Linux, windows, and Unix.

In some embodiments, the electronic device displays a post-operation region corresponding to a current resource, the post-operation region is configured to post comment information, and the post-operation region includes an image generation component. In the case that the post-operation region includes source comment information, an image set is displayed in the post-operation region in response to triggering the image generation component. The image set is generated based on the source comment information.

In some embodiments, databases corresponding to the electronic device and the server are both node devices in a blockchain system, which can share acquired and generated information with other node devices in the blockchain system, thus realizing information sharing among a plurality of node devices. The plurality of node devices in the blockchain system are configured with the same blockchain. The blockchain is composed of a plurality of blocks, with adjacent blocks being related to each other. In this way, tampering with data in any block can be detected by the next block, thereby preventing the data in the blockchain from being tampered with and ensuring data security and reliability.

FIG. 2 is a flowchart of a method for processing comments according to some embodiments of the present disclosure. As shown in FIG. 2, the embodiments of the present disclosure are executed by an electronic device, and the flowchart includes at least the following S201-S203.

In S201, a post-operation region of comment information corresponding to a current playing resource is displayed. The post-operation region includes an image generation component.

In the embodiments of the present disclosure, the post-operation region is a region on a page of an application program loaded on the electronic device, or a region on a webpage of a browser on the electronic device. Taking the electronic device loaded with an application as an example, the electronic device displays the post-operation region of the comment information corresponding to the current resource that is playing. The post-operation region includes the image generation component. That is, the electronic device displays the post-operation region corresponding to the current resource. The current resource is playing or paused or in other playing states. The post-operation region is configured to post the comment information. For example, the post-operation region is disposed on the same page as the current resource, and the post-operation region is disposed below the playing region of the current resource. The comment information for the current resource can be posted in the post-operation region.

In some embodiments, the application is a short video application, an information application, a game application, or the like. In some embodiments, the current resource includes a video resource, an audio resource, an image resource, or the like.

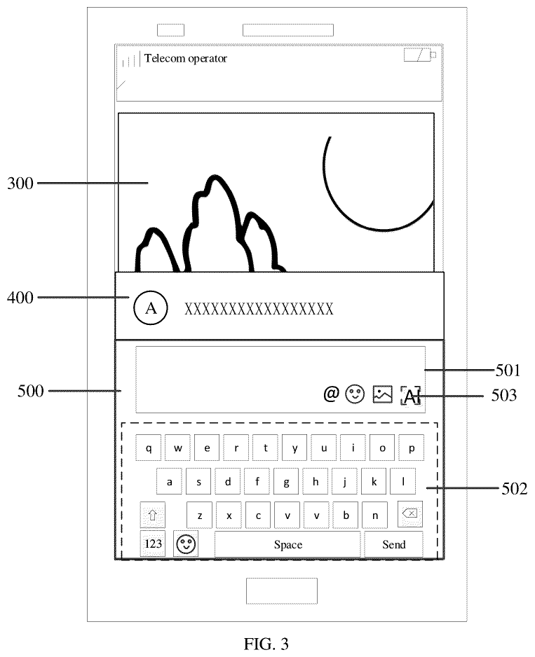

FIG. 3 is a schematic diagram 1 of a page on the electronic device according to some embodiments of the present disclosure. As shown in FIG. 3, the page includes a resource play page 300, a comment display page 400, and a comment operation page 500.

With reference to FIG. 3, the following descriptions provide an example in which the application is a short video application and the current playing resource is a video resource. In the embodiments of the present disclosure, when the video resource is played on the resource play page 300 in the short video application, a comment display component is also displayed on the resource play page 300.

In some embodiments, the electronic device detects that the comment display component is tapped, and displays the comment display page 400 in response to a comment page display instruction triggered based on the comment display component. In some embodiments, the comment display page 400 is disposed above the resource play page 300, and the comment display page 400 is not a full-screen page. In other embodiments, the comment display page 400 is a full-screen page.

As shown in FIG. 3, comment information on the current playing resource posted by different users is displayed on the comment display page 400 (some comments displayed on the comment display page 400 are blocked by the comment operation page 500), and the viewer can browse more comment information by sliding up and down.

In the embodiments of the present disclosure, the comment display page 400 includes a comment operation call-up component. The electronic device detects that the comment operation call-up component is tapped, and displays the comment operation page 500 in response to a comment operation calling instruction triggered based on the comment operation call-up component. The comment operation call-up component is an input box arranged at the bottom of the comment display page 400 or another component.

As shown in FIG. 3, the entire comment operation page 500 is a post-operation region, which includes an information input region 501 and an input operation region 502 (the region enclosed by dashed lines). An image generation component 503 is displayed in the information input region 501 and a virtual keyboard panel is displayed in the input operation region 502. In some embodiments, the image generation component is referred to as an artificial intelligence (AI) image button.

In some embodiments, the image generation component 503 is resident in the information input region 501. To be specific, the image generation component 503 is displayed in the information input region 501 every time the information input region 501 is displayed. In other embodiments, the image generation component 503 is displayed in the information input region 501, but is not resident in the information input region 501. To be specific, when the information input region 501 is displayed, the image generation component 503 is not displayed at first, but is displayed when the source comment information input into the information input region 501 meets a preset condition. The preset condition includes that the number of characters of the source comment information meets a preset number of characters, or other conditions, which are not limited in the embodiments of the present disclosure.

As shown in FIG. 3, the information input region 501 further includes other components, such as an object reminder component “@”, an emoji package component, and a storage region image selection component.

In other embodiments, the image generation component is provided in a shortcut posting region below the information input region. The shortcut posting region displays the image generation component, and recently posted emoji or images, and so on. Alternatively, the image generation component appears next to the source comment information according to the position of the source comment information on the comment operation page.

In S203, in the case that the post-operation region includes the source comment information, the image set generated based on the source comment information is displayed in the post-operation region in response to an image generation instruction triggered based on the image generation component. The image set includes a target image to be used as comment information for posting.

The image generation instruction is triggered based on the image generation component. In other words, the image generation instruction is generated in the case that the image generation component is triggered. Therefore, the S203 is equivalent to that the electronic device displays the image set in the post-operation region in response to triggering the image generation component.

In some embodiments, the image generation component included in the post-operation region, that is, the image generation component included in the information input region is always in a triggerable state. In the case that the source comment information is input into the information input region in the post-operation region, in response to the image generation instruction triggered by the image generation component which is always in the triggerable state, the electronic device loads the image set generated based on the source comment information, and then displays the image set in the post-operation region.

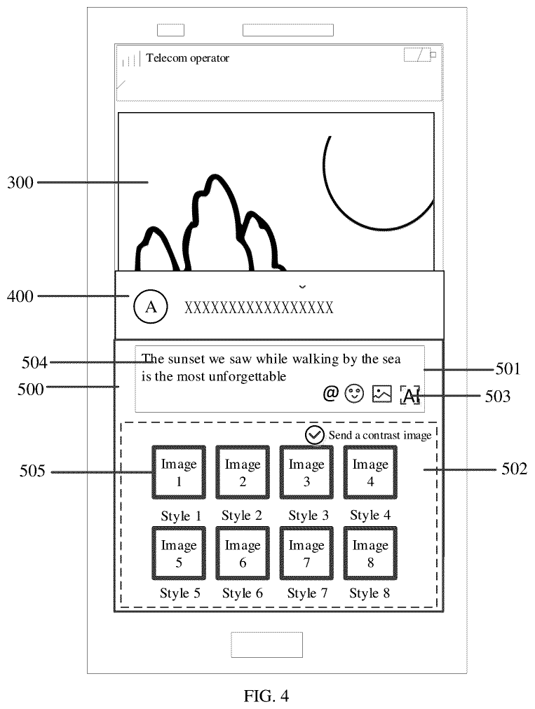

FIG. 4 is a schematic diagram 2 of a page on the electronic device according to some embodiments of the present disclosure. As shown in FIG. 4, the page shows not only the resource play page 300, the comment display page 400, and the comment operation page 500 including the information input region 501, the input operation region 502, and the image generation component 503 shown in FIG. 3, but also shows source comment information and an image set 505 in the information input region 501.

The embodiments are described below in detail with reference to FIG. 3 and FIG. 4. When the source comment information, for example, “The sunset we saw while walking by the sea is the most unforgettable”, is input into the information input region shown in FIG. 3 or FIG. 4, the user taps on the image generation component, and the electronic device, in response to the image generation instruction triggered based on the image generation component, displays in the input operation region an image panel shown in FIG. 4 switched from the virtual keyboard panel shown in FIG. 3, and displays on the image panel the image set generated based on the source comment information. Merely some images generated based on the source comment information are displayed on the image panel as an example, and other images are loaded and shown by sliding (sliding up, sliding down, sliding left or sliding right) or pulling down on the image panel.

That is, the post-operation region includes the information input region and the input operation region. The image generation component is displayed in the information input region and the virtual keyboard panel is displayed in the input operation region, such that the information can be input into the information input region through the virtual keyboard panel. In the case that the information input region displays the source comment information, the image set is displayed in the input operation region in response to triggering the image generation component. In the above embodiments, for example, the virtual keyboard panel is switched to the image panel in the input operation region. In other embodiments, both the virtual keyboard panel and the image panel are displayed in the input operation region. Alternatively, the input operation region is divided into two pages to display the virtual keyboard panel and the image panel respectively, and the two pages can be switched.

In some embodiments, each image in the image set has the same style, or the images in the image set have different styles as shown in FIG. 4, to avoid style repetition. The different styles include styles 1 to 8 indicating a 3D scene style, a photographic realism style, a watercolor style, a comic style, and so on.

In some embodiments, the image panel also includes a regeneration component. In the case that the regeneration component, such as a “next batch” component, is tapped, a new batch of images is generated, and the styles of the newly generated images are also different. In some embodiments, the styles of the images generated successively in the same position are consistent. In some embodiments, the style of the regenerated image is different from that of the previous image.

In some embodiments, the style degree of an image can be adjusted. For example, the degree of watercolor style of a watercolor image can be adjusted to the highest.

In some embodiments, in the case that a regeneration instruction for an image is detected, the style of the image is retained and an image with the same style but different content is regenerated.

In some embodiments, the electronic device generates a plurality of images for a selected style, and the plurality of images are all in the selected style. In some embodiments, the electronic device performs detail optimization on the selected image in response to an image optimization instruction.

In other embodiments, the image generation component included in the post-operation region, that is, the image generation component included in the information input region, is not always in the triggerable state, but only changes from a non-triggerable state to the triggerable state after a specific condition is met, and then is triggered. Alternatively, the image generation component is not displayed in the post-operation region at first, but is displayed in the post-operation region after a specific condition is met, and it can be triggered in the triggerable state.

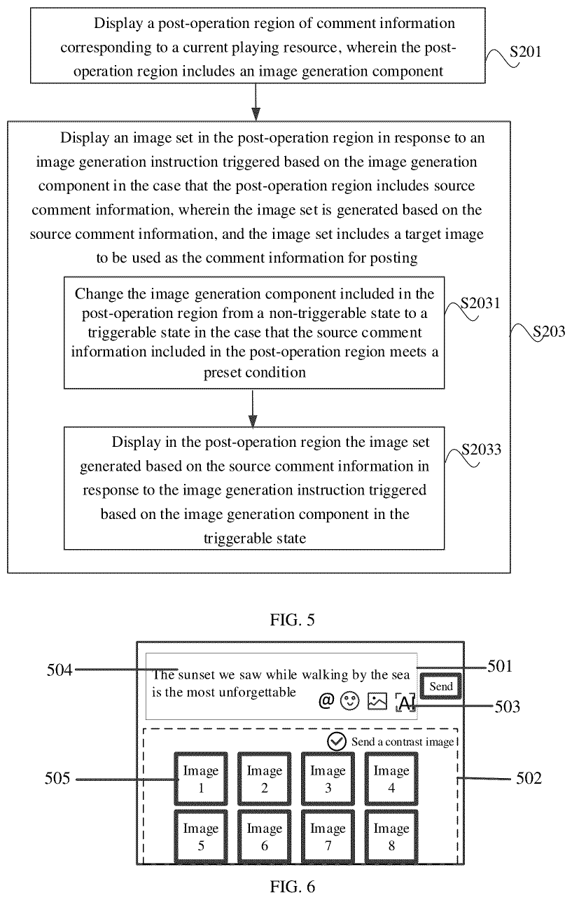

FIG. 5 is a flowchart of a method for processing comments according to some embodiments of the present disclosure. The method includes the following steps:

In S2031, when the source comment information included in the post-operation region meets a preset condition, the image generation component included in the post-operation region is changed from the non-triggerable state to the triggerable state.

In the embodiments of the present disclosure, in the case that the source comment information is input into the information input region in the post-operation region, whether the source comment information meets the preset condition is determined. In the case that the source comment information meets the preset condition, the image generation component in the post-operation region changes from the non-triggerable state to the triggerable state; otherwise, the image generation component remains in the non-triggerable state.

In the embodiments of the present disclosure, the image generation component changes from the non-triggerable state to the triggerable state, and this state change is indicated to the user through a color change. For example, the image generation component is gray in the non-triggerable state, and is yellow in the triggerable state. In addition to color changes, the electronic device may employ other means to indicate the state change of the image generation component.

In the embodiments of the present disclosure, different source comment information corresponds to different preset conditions, and the different source comment information is described as follows:

In some embodiments, the source comment information is character comment information. FIG. 6 is a schematic diagram 1 of the source comment information according to some embodiments of the present disclosure. FIG. 6 shows a comment operation region. Character comment information 504 is input in an input box in the information input region 501.

In some embodiments, when it is detected that the character comment information is input in the input box, the image generation component included in the post-operation region changes from the non-triggerable state to the triggerable state. In this way, the preset condition includes detecting that the character comment information is input in the input box.

In other embodiments, when it is detected that the character comment information is input in the input box and the number of characters in the character comment information meets a preset number of characters, the image generation component included in the post-operation region changes from the non-triggerable state to the triggerable state. In this way, the subsequent triggering of the image generation component can generate an image set through an AI image generation model corresponding to the image generation component, thus ensuring that the AI image generation model corresponding to the image generation component generates images based on a specific amount of character information. The number of characters in the character comment information meets the preset number of characters means that the number of characters in the character comment information is not less than the preset number of characters.

In some embodiments, the character comment information includes words, kaomoji, emoji, and the like.

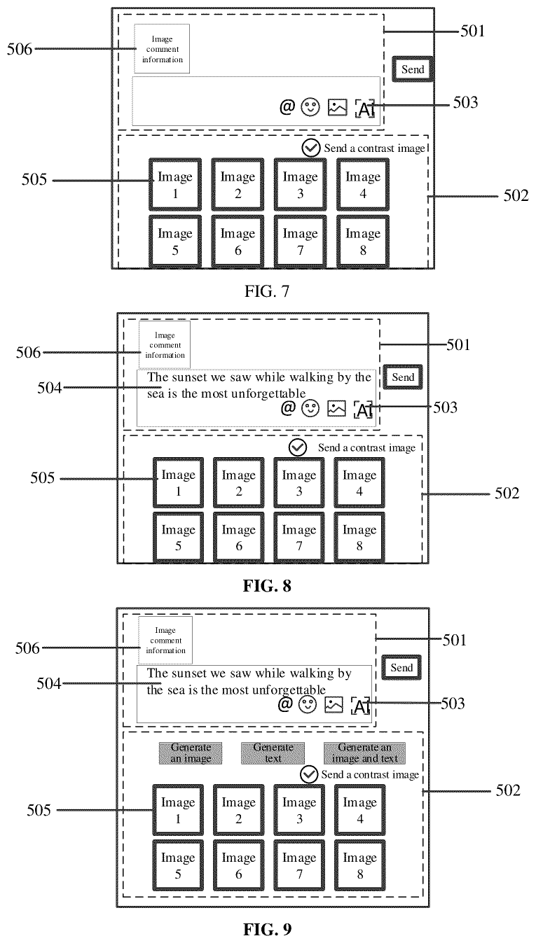

In some embodiments, the source comment information is image comment information. FIG. 7 is a schematic diagram 2 of the source comment information according to some embodiments of the present disclosure. FIG. 7 shows the comment operation region. The input image comment information 506 is displayed on the input box in the information input region 501.

In some embodiments, when the input image comment information is detected in the information input region, the image generation component included in the post-operation region changes from the non-triggerable state to the triggerable state.

In some embodiments, the source comment information includes the character comment information and the image comment information. FIG. 8 is a schematic diagram 3 of the source comment information according to some embodiments of the present disclosure. FIG. 8 shows the comment operation region. The character comment information 504 is input into the input box in the information input region 501, and the image comment information 506 as input is displayed above the input box.

In some embodiments, when the input character comment information and image comment information are detected in the information input region, the image generation component included in the post-operation region changes from the non-triggerable state to the triggerable state.

Alternatively, when the input character comment information and image comment information are detected in the information input region, and the number of characters in the character comment information meets a preset number of characters, the image generation component included in the post-operation region changes from the non-triggerable state to the triggerable state. In this way, the subsequent triggering of the image generation component can generate an image set through an AI image generation model corresponding to the image generation component, thus ensuring that the AI image generation model corresponding to the image generation component generates images based on a specific amount of character information.

In some embodiments, changing the image generation component from the non-triggerable state to the triggerable state can be realized not only according to the above-mentioned actual content input, but also by the following ways, such as inputting a space and source comment information, inputting a slash (\) and source comment information, double-tapping the input box, and long-pressing the input box.

In S2033, in response to the image generation instruction triggered based on the image generation component in the triggerable state, the image set generated based on the source comment information is displayed in the post-operation region.

The image generation instruction is triggered based on the image generation component in the triggerable state. In other words, in the case that the image generation component in the triggerable state is triggered, the image generation instruction is generated. Therefore, the S203 is equivalent to that the electronic device displays the image set in the post-operation region in response to triggering the image generation component in the triggerable state.

In the embodiments of the present disclosure, in the case that the source comment information is the character comment information, in response to the image generation instruction triggered based on the image generation component in the triggerable state, the electronic device displays in the post-operation region the image set generated based on the character comment information.

In some embodiments, in the case that the source comment information is the image comment information, in response to the image generation instruction triggered based on the image generation component in the triggerable state, the electronic device displays in the post-operation region the image set generated based on the image comment information.

In some embodiments, in the case that the source comment information includes the character comment information and the image comment information, in response to the image generation instruction triggered based on the image generation component in the triggerable state, the electronic device displays in the post-operation region the image set generated based on at least one of the character comment information and the image comment information.

FIG. 9 is a schematic diagram 4 of the source comment information according to some embodiments of the present disclosure. FIG. 9 shows the comment operation region. A plurality of pieces of generation information are displayed on the image panel displayed in the input operation region. The plurality of pieces of generation information is provided at the top of the image panel.

In the embodiments of the present disclosure, in the case that the source comment information displayed in the information input region includes the image comment information and the character comment information, in response to the image generation instruction triggered based on the image generation component, the electronic device displays the image panel switched from the virtual keyboard panel in the input operation region. In some embodiments, the image panel is displayed directly in the input operation region without switching the virtual keyboard panel to the image panel.

In some embodiments, the image panel includes first generation information (the “image generation” component shown in FIG. 9) and second generation information (the “text generation” component shown in FIG. 9). In response to a first generation instruction corresponding to the first generation information, the electronic device displays on the image panel the image set generated based on the image comment information. Alternatively, in response to a second generation instruction corresponding to the second generation information, the electronic device displays on the image panel the image set generated based on the character comment information. That is, in response to triggering the first generation information, the electronic device displays on the image panel the image set generated based on the image comment information; or in response to triggering the second generation information, displays on the image panel the image set generated based on the character comment information.

In some embodiments, the image panel includes first generation information (the “image generation” component shown in FIG. 9), second generation information (the “text generation” component shown in FIG. 9), and third generation information (the “image and text generation” component shown in FIG. 9). In response to a first generation instruction corresponding to the first generation information, the electronic device displays on the image panel the image set generated based on the image comment information. Alternatively, in response to a second generation instruction corresponding to the second generation information, the electronic device displays on the image panel the image set generated based on the character comment information. Alternatively, in response to a third generation instruction corresponding to the third generation information, the electronic device displays on the image panel the image set generated based on the image comment information and the character comment information. That is, in response to triggering the first generation information, the electronic device displays on the image panel the image set generated based on the image comment information; in response to triggering the second generation information, displays on the image panel the image set generated based on the character comment information; or in response to triggering the third generation information, displays on the image panel the image set generated based on the image comment information and the character comment information.

In some embodiments, when it is detected that the image generation component is tapped again, the input operation region switches from the image panel to the virtual keyboard panel, and the user inputs the comment information into the information input region by tapping on another component in the information input region, or through the virtual keyboard panel in the input operation region.

In the embodiments of the present disclosure, the image generation component for generating images is a back-end image generation model for generating images based on the principle of AI. That is, the electronic device generates the image set based on the source comment information through the image generation model. When training the image generation model, it is trained by character information, or by image information, or by both character information and image information.

In some embodiments, the image generation model is trained by: acquiring sample information, and training the image generation model based on the sample information. The sample information includes sample character information and sample images corresponding to the sample character information, and the content of the sample images is related to the sample character information. Alternatively, the sample information includes sample image information and sample images corresponding to the sample image information, and the sample images and the sample image information are related but have different image content. Alternatively, the sample information includes sample character information, sample image information, and corresponding sample images, the content of the sample images is related to the sample character information and the sample image information, but the sample images and the sample image information have different image content. By means of training, the image generation model has the function of automatically generating an image according to input information.

In the embodiments of the present disclosure, the generated image set is displayed on the image panel, and the electronic device further processes the images in the image set according to the operation of the user. In some embodiments, the electronic device displays an first image as enlarged on the post-operation region in response to a preview instruction for the first image in the image set.

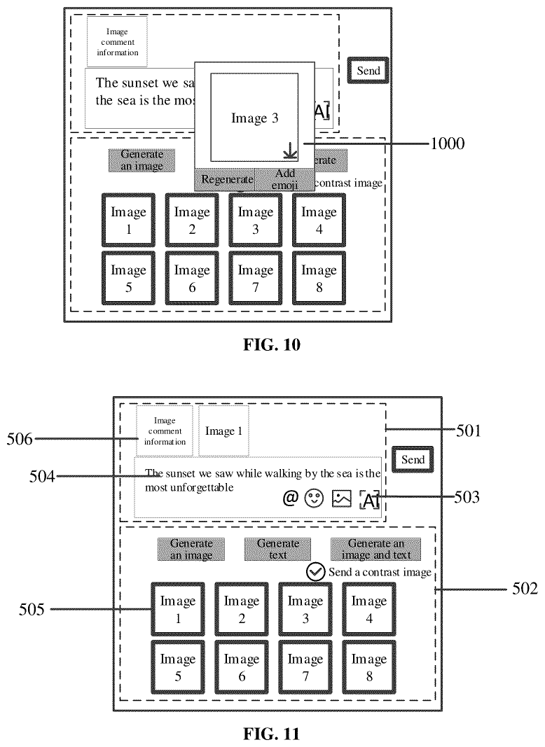

FIG. 10 is a schematic diagram 5 of the source comment information according to some embodiments of the present disclosure. As shown in FIG. 10, when the electronic device detects a long press by the user on the first image within the image panel, such as an image 3, the electronic device generates the preview instruction for the first image, displays an image browsing window 1000 in the post-operation region, and displays the first image as enlarged in the image browsing window for the user to better view the details of the first image, which facilitates the user in deciding whether to select the first image as comment information for posting.

In some embodiments, the image browsing window 1000 has a preset size, and the image browsing window 1000 may be further enlarged according to the user's operation, such that the first image displayed in the image browsing window 1000 can be adaptively enlarged for the user to better view the details. This facilitates the user in deciding whether to select the first image as comment information for posting.

As shown in FIG. 10, in the image browsing window 1000 on the post-operation region, in addition to the enlarged first image, operation information for the first image may also be displayed, such as at least one of regeneration information or “save to a preset storage region” information.

In some embodiments, the electronic device detects a regeneration instruction corresponding to the regeneration information, and generates, based on the source comment information, a second image for replacing the first image. When the electronic device detects the regeneration information, for example, when a screen region corresponding to a regeneration component in FIG. 10 is tapped, the electronic device generates, based on the source comment information, the second image for replacing the first image. That is, in response to triggering the regeneration information, the electronic device generates the second image for replacing the first image based on the source comment information. In some embodiments, the second image and the first image have the same style.

In some embodiments, the electronic device detects a “save to a preset storage region” instruction corresponding to the “save to a preset storage region” information, and saves the first image to the preset storage region. That is, the electronic device saves the first image to the preset storage region in response to triggering the “save to a preset storage region” information. The preset storage region includes a shortcut region or a storage region of the electronic device, such as an album.

For example, the electronic device detects that a screen region corresponding to an “adding emoji” component is tapped, and saves the first image to an emoji shortcut region. The electronic device detects that a screen region corresponding to a “download arrow” component in the lower-right corner of the first image is tapped in the image browsing window, and saves the first image to the storage region of the electronic device, such as the album. In the embodiments of the present disclosure, the electronic device displays a target image in the information input region in response to a selection instruction for the target image in the image set. The selection instruction is triggered by a select operation. In other words, the electronic device displays the target image in the information input region in response to the select operation on the target image in the image set.

FIG. 11 is a schematic diagram of adding the target image according to some embodiments of the present disclosure. As shown in FIG. 11, when the target image (such as the image 1) in the image set is tapped, the electronic device detects that the image 1 is selected, and determines the image 1 as the target image based on the generated selection instruction and displays the image 1 in the information input region. In some embodiments, the target image is displayed above the input box in the information input region.

In some embodiments, there are one or more target images which are displayed above the input box. In some embodiments, in the case that the source comment information includes the image comment information and the target image is displayed in the information input region, the image comment information is not displayed above the input box to make room for displaying the target image.

In the embodiments of the present disclosure, the information input region or the comment operation region includes a posting component, such as a “send” component in FIG. 10. The electronic device displays at least the target image on a comment display page in response to the posting instruction triggered based on the posting component. That is, the electronic device displays at least the target image on a comment display page in response to triggering the posting component.

In some embodiments, the electronic device displays the target image on the comment display page in response to the posting instruction triggered based on the posting component. That is, the electronic device displays the target image on the comment display page in response to triggering the posting component.

In other embodiments, the electronic device displays the target image and the source comment information on the comment display page in response to the posting instruction triggered based on the posting component. That is, the electronic device displays the target image and the source comment information on the comment display page in response to triggering the posting component.

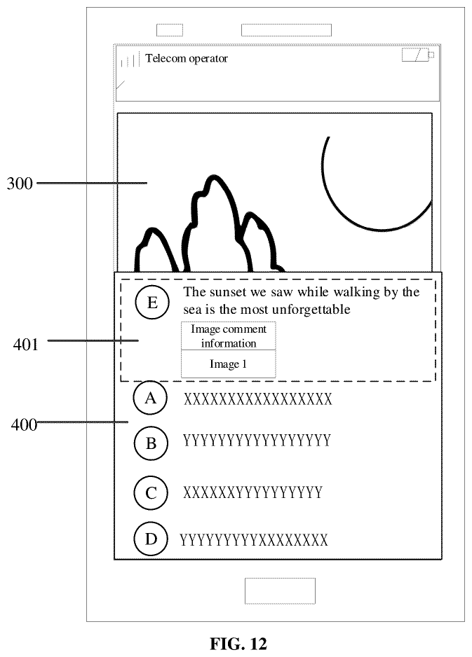

FIG. 12 is a schematic diagram of the comment display page according to some embodiments of the present disclosure. As shown in FIG. 12, the comment display page 400 includes posted comment information 401. The comment information 401 includes the source comment information and the target image.

In some embodiments, in the case that the source comment information includes the image comment information, before tapping the posting component, “post a contrast image” in the input operation region 502 shown in FIG. 11 is checked. Thus, after the comment information is posted, a spliced image of the image comment information and the target image is displayed on the comment display page, that is, the target image and the image comment information are displayed in a spliced form.

In some embodiments, as shown in FIG. 10, the target image and the image comment information are displayed in a spliced way, and the display size of the image comment information and the target image is compressed, such as by reducing the width of the images. When the spliced image is detected to be tapped, an image display window is displayed on the comment display page, and the target image and image comment information with the normal sizes are displayed in the image display window.

In the embodiments of the present disclosure, in order to enable other users to understand the AI image generation function provided by the platform, a function application link, that is, an active tag, corresponding to the image generation component is displayed in a preset region corresponding to the target image on the comment display page. The function application link indicates to reserve application of the image generation component or to apply the image generation component through the function application link. In this way, when another electronic device displays the comment display page, the target image and the function application link are both displayed, so as to reserve application of the image generation component or to apply the image generation component through the function application link.

In some embodiments, the preset region corresponding to the target image is the lower position in the target image or the spliced image, or the left or right position in the target image or the spliced image.

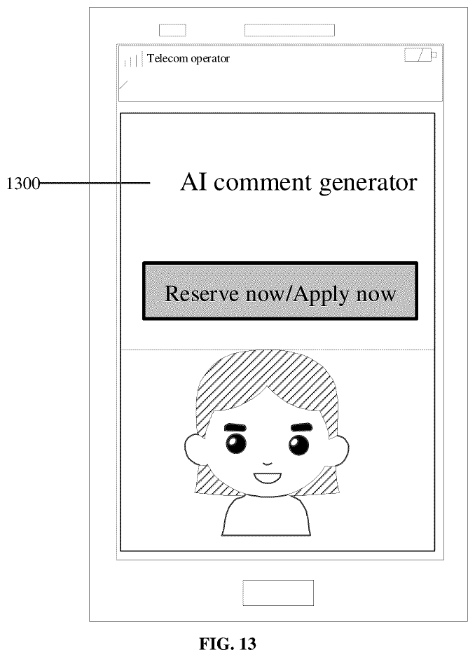

FIG. 13 is a schematic diagram of the application page according to some embodiments of the present disclosure. As shown in FIG. 13, an application page 1300 is included.

In some embodiments, the electronic device detects that the function application link is tapped and jumps to the application page, which includes a “reserve now” component or an “apply now” component.

In some embodiments, the electronic device sends a reservation request to a server in response to a reservation instruction corresponding to the “reserve now” component, and after receiving feedback of a successful reservation, applies the image generation component when commenting. The server reserves application of the image generation component for the electronic device, indicating that the electronic device is allowed to use the image generation component. For example, the server marks an account logged in with the electronic device, indicating a successful reservation for the account. Subsequently, the electronic device can display the image generation component in the post-operation region corresponding to any resource, so as to generate the image by triggering the image generation component.

In some embodiments, the electronic device jumps from the application page to the page in FIG. 3 in response to the experience instruction corresponding to the “apply now” component.

In the embodiments of the present disclosure, when the user taps the image generation component and the virtual keyboard panel switches to the image panel, other components in the input box are locked and become non-triggerable.

In some embodiments, the electronic device switches from the image panel to the virtual keyboard panel when it detects that a “close” component or a blank region on the image panel is tapped.

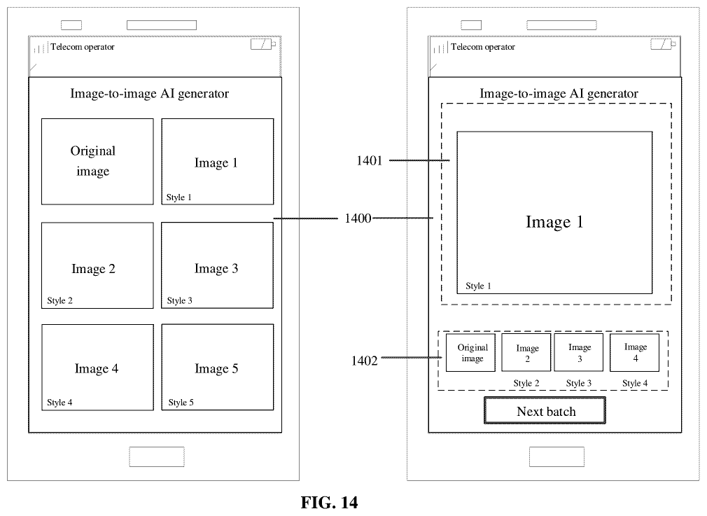

In the embodiments of the present disclosure, the image panel is displayed on the page in other forms. FIG. 14 is a schematic diagram of the image page according to some embodiments of the present disclosure. As shown in FIG. 14, in the embodiments of the present disclosure, when the post-operation region shown in FIG. 6 to FIG. 8 includes the source comment information, the electronic device switches to and displays a full-screen image page 1400 in response to the image generation instruction triggered based on the image generation component, and displays on the image page 1400 the image set that includes images of various styles and is generated based on the source comment information. In other words, when the post-operation region includes the source comment information, the image set is displayed on the full-screen image page in response to triggering the image generation component, and the image set includes images of at least two styles. For example, each image in the image set has a different style, or the image set includes images with different styles and images with the same style.

In some embodiments, the source comment information includes the image comment information, and the image set includes the image comment information, for example, an “original image” in FIG. 14.

In some embodiments, the source comment information includes the image comment information, and the image set includes the image comment information and images generated based on the image comment information. As shown in the image page on the left in FIG. 14, the electronic device displays on the image page the uniformly displayed image set generated based on the image comment information. The uniformly displayed image set includes the image comment information and generated images of various styles, and the image page displays more images of other styles through a drop-down menu or other instructions. That is, the electronic device uniformly displays the images in the image set on the image page. In other words, the displayed images have the same size.

In some embodiments, the source comment information includes the image comment information, and the image set includes the image comment information and images generated based on the image comment information. As shown in the image page on the right in FIG. 14, the electronic device displays on the image page the image set generated based on the image comment information with different image sizes. The image page includes a primary display region 1401 and a secondary display region 1402. Any image in the image set is displayed in the primary display region, and the remaining images other than the one displayed in the primary display region are displayed in the secondary display region. The size of the primary display region is larger than that of the secondary display region.

In some embodiments, the images displayed in the primary display region and the secondary display region are switched by a switching instruction, and the switching instruction is triggered by tapping any image in the secondary display region, such that the triggered image is displayed in the primary display region, and the image previously displayed in the primary display region is displayed in the tapped secondary display region.

In some embodiments, the electronic device also updates the images displayed in the primary display region and the secondary display region through a “next batch” component on the figure to obtain completely different images.

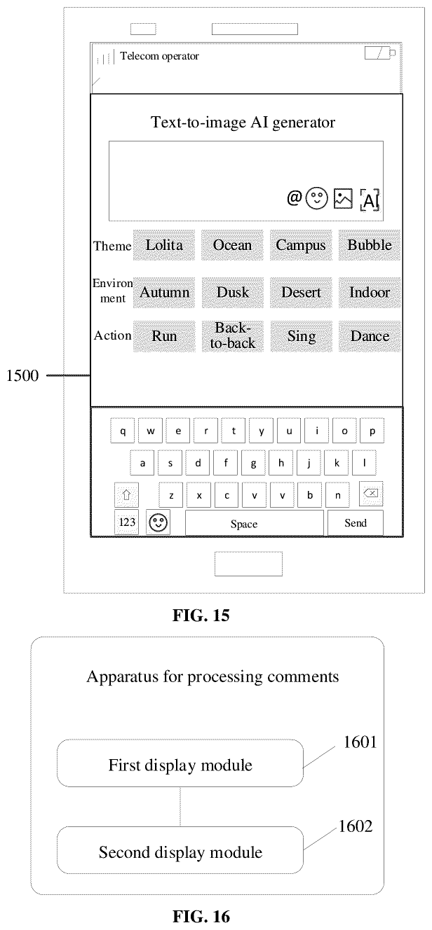

FIG. 15 is a schematic diagram of the input page according to some embodiments of the present disclosure. As shown in FIG. 15, the input page is an input page 1500.

In the embodiments of the present disclosure, the electronic device detects an input instruction corresponding to the information input region 501 included in the post-operation region, that is, the electronic device detects that the screen corresponding to the information input region 501 is tapped, and switches to and displays the full-screen input page. The input page includes the input box, the image generation component in the input box, a virtual keyboard, and a plurality of types of text sets.

In some embodiments, the plurality of types include at least two types such as the theme, environment, or action. The theme type includes text representations such as lolita, ocean, and campus. The environment type includes text representations such as autumn, dusk, and desert. The action type includes text representations such as running, back-to-back, and singing. Certainly, the illustrated examples are not exhaustive, and there may be other types and text representations.

In some embodiments, the electronic device displays target text in the input box in response to a determining instruction for the target text in the text set corresponding to a target type in the plurality of types, and displays the image page in response to the image generation instruction triggered based on the image generation component, and displays in the image page the image set generated based on the target text. In some embodiments, the target type includes one or more of the types mentioned above, and correspondingly, the target text also includes one or more pieces of text. In other words, the target text is text in the text set corresponding to any of the above types. After the target text is displayed in the input box, the target text is the source comment information. In response to triggering the image generation component, the electronic device generates the image set based on the source comment information and displays the image set on the image page.

For the embodiments of displaying on the image page the image set generated based on the target text, refer to the embodiments in the above figures.

FIG. 16 is a block diagram of an apparatus for processing comments according to some embodiments of the present disclosure. The apparatus is applied to an electronic device, and has the function of implementing the method for processing comments in the above method embodiments. The function can be realized by hardware or by hardware executing corresponding software. As shown in FIG. 16, the apparatus includes a first display module 1601 and a second display module 1602.

The first display module 1601 is configured to display a post-operation region corresponding to a current resource, wherein the post-operation region is configured to post comment information and includes an image generation component.

The second display module 1602 is configured to display an image set in the post-operation region in response to triggering the image generation component in a case that the post-operation region includes source comment information, wherein the image set is generated based on the source comment information.

In some embodiments, the second display module 1602 is configured to:
change the image generation component from a non-triggerable state to a triggerable state in the case that the source comment information meets a preset condition; and
display the image set in the post-operation region in response to triggering the image generation component in the triggerable state.

In some embodiments, the second display module 1602 is configured to:
change the image generation component from the non-triggerable state to the triggerable state in a case that the source comment information is character comment information and a number of characters in the character comment information meets a preset number of characters;
change the image generation component from the non-triggerable state to the triggerable state in a case that the source comment information is image comment information; or
change the image generation component from the non-triggerable state to the triggerable state in the case that the source comment information includes image comment information and character comment information.

In some embodiments, the first display module 1601 is configured to:
display an information input region and an input operation region corresponding to the current resource; and
display the image generation component in the information input region and display a virtual keyboard panel in the input operation region; and
the second display module 1602 is configured to:
display the image set in the input operation region in response to triggering the image generation component in the case that the information input region displays the source comment information.

In some embodiments, the second display module 1602 is configured to:
display an image panel in the input operation region in response to triggering the image generation component in a case that the source comment information displayed in the information input region includes image comment information and character comment information, wherein the image panel includes first generation information and second generation information; and
display on the image panel the image set generated based on the image comment information in response to triggering the first generation information; or display on the image panel the image set generated based on the character comment information in response to triggering the second generation information.

In some embodiments, the apparatus further includes a third display module, configured to:
display a first image as enlarged on the post-operation region in response to a preview instruction on the first image in the image set.

In some embodiments, the third display module is configured to:
display the first image as enlarged and operation information for the first image on the post-operation region, wherein the operation information includes at least one of regeneration information or “save to a preset storage region” information; and
generate, based on the source comment information, a second image for replacing the first image in response to triggering the regeneration information; or save the first image to the preset storage region in response to triggering the “save to a preset storage region” information.

In some embodiments, the post-operation region includes an information input region and an input operation region, and the second display module 1602 is configured to:
display the image set in the input operation region;
display a target image in the information input region in response to a select operation on the target image in the image set, wherein the information input region includes a posting component; and
display at least the target image on a comment display page in response to triggering the posting component.

In some embodiments, the second display module 1602 is configured to:
display the target image and the source comment information on the comment display page in response to triggering the posting component.

In some embodiments, the second display module 1602 is further configured to:
in a case that the source comment information includes image comment information, display the target image and the image comment information in a spliced form in response to triggering the posting component.

In some embodiments, the apparatus further includes a fourth display module, configured to:
display a function application link of the image generation component in a preset region corresponding to the target image on the comment display page, wherein
the function application link is configured to reserve an application of the image generation component or to apply the image generation component.

In some embodiments, the second display module 1602 is configured to:
display the image set on a full-screen image page in response to triggering the image generation component in the case that the post-operation region includes the source comment information, wherein the image set includes images of at least two styles.

In some embodiments, the source comment information includes the image comment information, the image set includes the image comment information and images generated based on the image comment information, and the second display module 1602 is configured to:
display the images in the image set on the image page uniformly; or
display any image in the image set in a primary display region and display in a secondary display region remaining images other than the image displayed in the primary display region, wherein the image page includes the primary display region and the secondary display region, and a size of the primary display region is larger than a size of the secondary display region.

In some embodiments, the second display module 1602 is configured to:
display a full-screen input page in response to detecting an input operation in the post-operation region, wherein the input page includes an input box, the image generation component, and a plurality of text sets corresponding to a plurality of types, and the plurality of types include at least two of a theme, an environment, or an action;
display target text in the input box in response to a determining instruction on the target text, wherein the target text is text in the text set corresponding to any one of the plurality of types; and
display on an image page the image set generated based on the target text in response to triggering the image generation component.

In some embodiments, the image set is generated based on the source comment information by an image generation model corresponding to the image generation component.

It should be noted that when the apparatus provided in the foregoing embodiments implements its functions, the division of the foregoing function modules is merely used as an example. In practical application, the foregoing functions may be allocated to and completed by different function modules as required, that is, an internal structure of the apparatus is divided into different function modules to complete all or some of the foregoing functions. In addition, the apparatus provided in the foregoing embodiments belongs to the same conception as the embodiments of the method. For a specific implementation process, refer to the method embodiments, and details are not described herein again.

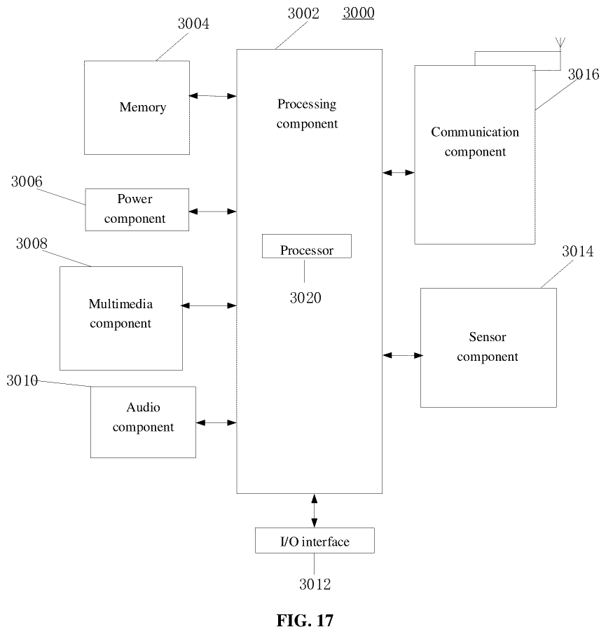

FIG. 17 is a block diagram of an electronic device 3000 for processing comments according to some embodiments of the present disclosure. For example, the electronic device 3000 is a mobile phone, a computer, a digital broadcast terminal, a message transceiving device, a gaming console, a tablet device, a medical device, a fitness device, a personal digital assistant, or the like.

Referring to FIG. 17, the electronic device 3000 includes one or more of the following components: a processing component 3002, a memory 3004, a power component 3006, a multimedia component 3008, an audio component 3010, an input/output (I/O) interface 3012, a sensor component 3014, and a communication component 3016.

The processing component 3002 typically controls the overall operation of the electronic device 3000, for example, operations associated with display, phone calls, data communications, camera operations, and recording operations. The processing component 3002 includes one or more processors 3020 to execute instructions to complete all or some of the steps of the method described above. In addition, the processing component 3002 may include one or more modules that facilitate interaction between the processing component 3002 and other components. For example, the processing component 3002 includes a multimedia module to facilitate interaction between the multimedia component 3008 and the processing component 3002.

The memory 3004 is configured to store various types of image data to support operations on the device 3000. Examples of such data include instructions for any application or method operating on the electronic device 3000, contact data, phone book data, messages, images, videos, etc. The memory 3004 is implemented by any type of transitory or non-transitory storage device or a combination thereof, for example, a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

The power component 3006 provides power to the various components of the electronic device 3000. The power component 3006 includes a power management system, one or more power supplies, and other components associated with power generation, management, and distribution for the electronic device 3000.

The multimedia component 3008 includes a screen providing an output interface between the electronic device 3000 and a user. In some embodiments, the screen includes a liquid crystal display (LCD) and a touch panel (TP). If the screen includes the TP, the screen is implemented as a touch screen to receive input signals from the user. The TP includes one or more touch sensors to sense touches, swipes, and gestures on the TP. The touch sensors not only sense boundaries of the touch or swipe action, but also detect the duration and pressure associated with the touch or swipe action. In some embodiments, the multimedia component 3008 includes a front-facing camera and/or a rear-facing camera. The front-facing camera and/or the rear-facing camera receive external multimedia data when the device 3000 is in the operating mode, such as a shooting mode or a video mode. Each front-facing camera and rear-facing camera is a fixed optical lens system or has a focal length and optical zoom capability.

The audio component 3010 is configured to output and/or input audio signals. For example, the audio component 3010 includes a microphone (MIC) configured to receive external audio signals when the electronic device 3000 is in an operating mode, such as a call mode, a recording mode, and a voice recognition mode. The received audio signals are further stored in the memory 3004 or sent via the communication component 3016. In some embodiments, the audio component 3010 further includes a speaker for outputting audio signals.

The I/O interface 3012 provides an interface between the processing component 3002 and a peripheral interface module, and the peripheral interface module is a keyboard, a click wheel, a button, etc. The buttons include, but are not limited to: a home button, a volume button, a start button, and a lock button.

The sensor component 3014 includes one or more sensors for providing status assessment of various aspects of the electronic device 3000. For example, the sensor component 3014 detects an on/off state of the device 3000, and the relative positioning of components, for example, the components are the display and keypad of the electronic device 3000. The sensor component 3014 also detects a position change of the electronic device 3000 or a component of the electronic device 3000, the presence or absence of user contact with the electronic device 3000, orientation or acceleration/deceleration of the electronic device 3000, and a temperature change of the electronic device 3000. The sensor component 3014 includes a proximity sensor configured to detect the presence of nearby objects without any physical contact. The sensor component 3014 further includes an optical sensor, such as a CMOS or CCD image sensor, for use in imaging applications. In some embodiments, the sensor component 3014 further includes an accelerometer sensor, a gyroscope sensor, a magnetic sensor, a pressure sensor, or a temperature sensor.

The communication component 3016 is configured to facilitate communication between the electronic device 3000 and other devices by wired or wireless means. The electronic device 3000 accesses a wireless network based on a communication standard, such as WiFi, a carrier network (e.g., 2G, 3G, 4G, or 5G), or a combination thereof. In some embodiments of the present disclosure, the communication component 3016 receives broadcast signals or broadcast-related information from an external broadcast management system via a broadcast channel. In some embodiments of the present disclosure, the communication component 3016 further includes a near-field communication (NFC) module to facilitate short-range communication. For example, the NFC module is implemented based on the radio frequency identification (RFID) technology, infrared data association (IrDA) technology, ultra-wideband (UWB) technology, Bluetooth (BT) technology, and other technologies.

In some embodiments of the present disclosure, the electronic device 3000 is implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components for performing the method described above.

The embodiments of the present disclosure provide an electronic device, including:
a processor; and
a memory, configured to store an instruction executable by the processor, wherein
the processor, when loading and running the instructions, is caused to perform:
displaying a post-operation region corresponding to a current resource, wherein the post-operation region is configured to post comment information and includes an image generation component; and
displaying an image set in the post-operation region in response to triggering the image generation component in a case that the post-operation region includes source comment information, wherein the image set is generated based on the source comment information.

In some embodiments, the processor, when loading and running the instructions, is caused to perform:
changing the image generation component from a non-triggerable state to a triggerable state in the case that the source comment information meets a preset condition; and
displaying the image set in the post-operation region in response to triggering the image generation component in the triggerable state.

In some embodiments, the processor, when loading and running the instructions, is caused to perform:
changing the image generation component from the non-triggerable state to the triggerable state in a case that the source comment information is character comment information and a number of characters in the character comment information meets a preset number of characters;
changing the image generation component from the non-triggerable state to the triggerable state in a case that the source comment information is image comment information; or
changing the image generation component from the non-triggerable state to the triggerable state in the case that the source comment information includes image comment information and character comment information.

In some embodiments, the processor, when loading and running the instructions, is caused to perform:
displaying an information input region and an input operation region corresponding to the current resource; and
displaying the image generation component in the information input region and displaying a virtual keyboard panel in the input operation region; and
the processor, when loading and running the instructions, is caused to perform:
displaying the image set in the input operation region in response to triggering the image generation component in a case that the information input region displays the source comment information.

In some embodiments, the processor, when loading and running the instructions, is caused to perform:
displaying an image panel in the input operation region in response to triggering the image generation component in a case that the source comment information displayed in the information input region includes image comment information and character comment information, wherein the image panel includes first generation information and second generation information; and
displaying on the image panel the image set generated based on the image comment information in response to triggering the first generation information; or displaying on the image panel the image set generated based on the character comment information in response to triggering the second generation information.

In some embodiments, the processor, when loading and running the instructions, is caused to perform:
displaying a first image as enlarged on the post-operation region in response to a preview instruction on the first image in the image set.

In some embodiments, the processor, when loading and running the instructions, is caused to perform:
displaying the first image as enlarged and operation information for the first image on the post-operation region, wherein the operation information includes at least one of regeneration information or “save to a preset storage region” information; and
generating, based on the source comment information, a second image for replacing the first image in response to triggering the regeneration information; or saving the first image to the preset storage region in response to triggering the “save to a preset storage region” information.

In some embodiments, the processor, when loading and running the instructions, is caused to perform:
displaying the image set in the input operation region;
displaying a target image in the information input region in response to a select operation on the target image in the image set, wherein the information input region includes a posting component; and
displaying at least the target image on a comment display page in response to triggering the posting component.

In some embodiments, the processor, when loading and running the instructions, is caused to perform:
displaying the target image and the source comment information on the comment display page in response to triggering the posting component.

In some embodiments, the processor, when loading and running the instructions, is caused to perform:
in the case that the source comment information includes image comment information, displaying the target image and the image comment information in a spliced form in response to triggering the posting component.

In some embodiments, the processor, when loading and running the instructions, is caused to perform:
displaying a function application link of the image generation component in a preset region corresponding to the target image on the comment display page, wherein
the function application link is configured to reserve an application of the image generation component or to apply the image generation component.

In some embodiments, the processor, when loading and running the instructions, is caused to perform:
displaying the image set on a full-screen image page in response to triggering the image generation component in the case that the post-operation region includes the source comment information, wherein the image set includes images of at least two styles.

In some embodiments, the source comment information includes the image comment information, the image set includes the image comment information and images generated based on the image comment information, and the processor, when loading and running the instructions, is caused to perform:
displaying the images in the image set on the image page uniformly; or
displaying any image in the image set in a primary display region and displaying in a secondary display region remaining images other than the image displayed in the primary display region, wherein the image page includes the primary display region and the secondary display region, and a size of the primary display region is larger than a size of the secondary display region.

In some embodiments, the processor, when loading and running the instructions, is caused to perform:
displaying a full-screen input page in response to detecting an input operation in the post-operation region, wherein the input page includes an input box, the image generation component, and a plurality of text sets corresponding to a plurality of types, and the plurality of types include at least two of a theme, an environment, or an action;
displaying target text in the input box in response to a determining instruction on the target text, wherein the target text is text in the text set corresponding to any one of the plurality of types; and
displaying on an image page the image set generated based on the target text in response to triggering the image generation component.

In some embodiments, the image set is generated based on the source comment information by an image generation model corresponding to the image generation component.

The embodiments of the present disclosure further provide a computer-readable storage medium, which can be arranged in an electronic device to store at least one instruction or at least one program for implementing the method for processing comments. The at least one instruction or the at least one program, when loaded and executed by the processor, causes the processor to realize the method for processing comments provided in the above method embodiments.

In some embodiments of the present disclosure, a storage medium including instructions is further provided, such as a memory 3004 including instructions, wherein the instructions are executed by the processor 3020 of the electronic device 3000 to accomplish the method described above. In some embodiments, the storage medium is a non-transitory computer-readable storage medium, for example, the non-transitory computer-readable storage medium is a ROM, a RAM, a CD-ROM, a magnetic tape, a floppy disk, an optical data storage device, or the like.

The embodiments of the present disclosure further provide a non-transitory computer-readable storage medium. When instructions in the non-transitory computer-readable storage medium, when executed by a processor of an electronic device, cause the electronic device to perform:
displaying a post-operation region corresponding to a current resource, wherein the post-operation region is configured to post comment information and includes an image generation component; and
displaying an image set in the post-operation region in response to triggering the image generation component in a case that the post-operation region includes source comment information, wherein the image set is generated based on the source comment information.

In some embodiments, the instructions in the non-transitory computer-readable storage medium, when executed by the processor of the electronic device, cause the electronic device to perform:
changing the image generation component from a non-triggerable state to a triggerable state in the case that the source comment information meets a preset condition; and
displaying the image set in the post-operation region in response to triggering the image generation component in the triggerable state.

In some embodiments, the instructions in the non-transitory computer-readable storage medium, when executed by the processor of the electronic device, cause the electronic device to perform:
changing the image generation component from the non-triggerable state to the triggerable state in a case that the source comment information is character comment information and a number of characters in the character comment information meets a preset number of characters;
changing the image generation component from the non-triggerable state to the triggerable state in a case that the source comment information is image comment information; or
changing the image generation component from the non-triggerable state to the triggerable state in the case that the source comment information includes image comment information and character comment information.

In some embodiments, the instructions in the non-transitory computer-readable storage medium, when executed by the processor of the electronic device, cause the electronic device to perform:
displaying an information input region and an input operation region corresponding to the current resource; and
displaying the image generation component in the information input region and displaying a virtual keyboard panel in the input operation region; and
when the instructions in the computer-readable storage medium are executed by the processor of the electronic device, the electronic device is caused to perform the following step:
displaying the image set in the input operation region in response to triggering the image generation component in a case that the information input region displays the source comment information.

In some embodiments, the instructions in the non-transitory computer-readable storage medium, when executed by the processor of the electronic device, cause the electronic device to perform:
displaying an image panel in the input operation region in response to triggering the image generation component in a case that the source comment information displayed in the information input region includes image comment information and character comment information, wherein the image panel includes first generation information and second generation information; and
displaying on the image panel the image set generated based on the image comment information in response to triggering the first generation information; or displaying on the image panel the image set generated based on the character comment information in response to triggering the second generation information.

In some embodiments, the instructions in the non-transitory computer-readable storage medium, when executed by the processor of the electronic device, cause the electronic device to perform:
displaying a first image as enlarged on the post-operation region in response to a preview instruction on the first image in the image set.

In some embodiments, the instructions in the non-transitory computer-readable storage medium, when executed by the processor of the electronic device, cause the electronic device to perform:
displaying the first image as enlarged and operation information for the first image on the post-operation region, wherein the operation information includes at least one of regeneration information or “save to a preset storage region” information; and
generating, based on the source comment information, a second image for replacing the first image in response to triggering the regeneration information; or saving the first image to the preset storage region in response to triggering the “save to a preset storage region” information.

In some embodiments, the instructions in the non-transitory computer-readable storage medium, when executed by the processor of the electronic device, cause the electronic device to perform:
displaying the image set in the input operation region;
displaying a target image in the information input region in response to a select operation on the target image in the image set, wherein the information input region includes a posting component; and
displaying at least the target image on a comment display page in response to triggering the posting component.

In some embodiments, the instructions in the non-transitory computer-readable storage medium, when executed by the processor of the electronic device, cause the electronic device to perform:
displaying the target image and the source comment information on the comment display page in response to triggering the posting component.

In some embodiments, the instructions in the non-transitory computer-readable storage medium, when executed by the processor of the electronic device, cause the electronic device to perform:
in the case that the source comment information includes image comment information, displaying the target image and the image comment information in a spliced form in response to triggering the posting component.

In some embodiments, the instructions in the non-transitory computer-readable storage medium, when executed by the processor of the electronic device, cause the electronic device to perform:
displaying a function application link of the image generation component in a preset region corresponding to the target image on the comment display page, wherein
the function application link is configured to reserve an application of the image generation component or to apply the image generation component.

In some embodiments, the instructions in the non-transitory computer-readable storage medium, when executed by the processor of the electronic device, cause the electronic device to perform:
displaying the image set on a full-screen image page in response to triggering the image generation component in the case that the post-operation region includes the source comment information, wherein the image set includes images of at least two styles.

In some embodiments, the source comment information includes the image comment information, the image set includes the image comment information and images generated based on the image comment information, and the instructions in the non-transitory computer-readable storage medium, when executed by the processor of the electronic device, cause the electronic device to perform:
displaying the images in the image set on the image page uniformly; or
displaying any image in the image set in a primary display region and displaying in a secondary display region remaining images other than the image displayed in the primary display region, wherein the image page includes the primary display region and the secondary display region, and a size of the primary display region is larger than a size of the secondary display region.

In some embodiments, the instructions in the non-transitory computer-readable storage medium, when executed by the processor of the electronic device, cause the electronic device to perform:
displaying a full-screen input page in response to detecting an input operation in the post-operation region, wherein the input page includes an input box, the image generation component, and a plurality of text sets corresponding to a plurality of types, and the plurality of types include at least two of a theme, an environment, or an action;
displaying target text in the input box in response to a determining instruction on the target text, wherein the target text is text in the text set corresponding to any one of the plurality of types; and
displaying on an image page the image set generated based on the target text in response to triggering the image generation component.

In some embodiments, the image set is generated based on the source comment information by an image generation model corresponding to the image generation component.

The embodiments of the present disclosure further provide a computer program product. The computer program product includes a computer program, the computer program is stored in a readable storage medium, wherein the computer program, when read and executed by at least one processor of a computer device, causes the computer device to perform:
displaying a post-operation region corresponding to a current resource, wherein the post-operation region is configured to post comment information and includes an image generation component; and
displaying an image set in the post-operation region in response to triggering the image generation component in a case that the post-operation region includes source comment information, wherein the image set is generated based on the source comment information.

In some embodiments, the computer program, when read and executed by at least one processor of the computer device, causes the computer device to perform:
changing the image generation component from a non-triggerable state to a triggerable state in the case that the source comment information meets a preset condition; and
displaying the image set in the post-operation region in response to triggering the image generation component in the triggerable state.

In some embodiments, the computer program, when read and executed by at least one processor of the computer device, causes the computer device to perform:
changing the image generation component from the non-triggerable state to the triggerable state in a case that the source comment information is character comment information and a number of characters in the character comment information meets a preset number of characters;
changing the image generation component from the non-triggerable state to the triggerable state in a case that the source comment information is image comment information; or
changing the image generation component from the non-triggerable state to the triggerable state in the case that the source comment information includes image comment information and character comment information.

In some embodiments, the computer program, when read and executed by at least one processor of the computer device, causes the computer device to perform:
displaying an information input region and an input operation region corresponding to the current resource; and
displaying the image generation component in the information input region and displaying a virtual keyboard panel in the input operation region; and
the computer program, when read and executed by at least one processor of the computer device, causes the computer device to perform:
displaying the image set in the input operation region in response to triggering the image generation component in a case that the information input region displays the source comment information.

In some embodiments, the computer program, when read and executed by at least one processor of the computer device, causes the computer device to perform:
displaying an image panel in the input operation region in response to triggering the image generation component in a case that the source comment information displayed in the information input region includes image comment information and character comment information, wherein the image panel includes first generation information and second generation information; and
displaying on the image panel the image set generated based on the image comment information in response to triggering the first generation information; or displaying on the image panel the image set generated based on the character comment information in response to triggering the second generation information.

In some embodiments, the computer program, when read and executed by at least one processor of the computer device, causes the computer device to perform:
displaying a first image as enlarged on the post-operation region in response to a preview instruction on the first image in the image set.

In some embodiments, the computer program, when read and executed by at least one processor of the computer device, causes the computer device to perform:
displaying the first image as enlarged and operation information for the first image on the post-operation region, wherein the operation information includes at least one of regeneration information or “save to a preset storage region” information; and
generating, based on the source comment information, a second image for replacing the first image in response to triggering the regeneration information; or saving the first image to the preset storage region in response to triggering the “save to a preset storage region” information.

In some embodiments, the computer program, when read and executed by at least one processor of the computer device, causes the computer device to perform:
displaying the image set in the input operation region;
displaying a target image in the information input region in response to a select operation on the target image in the image set, wherein the information input region includes a posting component; and
displaying at least the target image on a comment display page in response to triggering the posting component.

In some embodiments, the computer program, when read and executed by at least one processor of the computer device, causes the computer device to perform:
displaying the target image and the source comment information on the comment display page in response to triggering the posting component.

In some embodiments, the computer program, when read and executed by at least one processor of the computer device, causes the computer device to perform:
in the case that the source comment information includes image comment information, displaying the target image and the image comment information in a spliced form in response to triggering the posting component.

In some embodiments, the computer program, when read and executed by at least one processor of the computer device, causes the computer device to perform:
displaying a function application link of the image generation component in a preset region corresponding to the target image on the comment display page, wherein
the function application link is configured to reserve application of the image generation component or to apply the image generation component.

In some embodiments, the computer program, when read and executed by at least one processor of the computer device, causes the computer device to perform:
displaying the image set on a full-screen image page in response to triggering the image generation component in the case that the post-operation region includes the source comment information, wherein the image set includes images of at least two styles.

In some embodiments, the source comment information includes the image comment information, the image set includes the image comment information and images generated based on the image comment information, and the computer program, when read and executed by at least one processor of the computer device, causes the computer device to perform:
displaying the images in the image set on the image page uniformly; or
displaying any image in the image set in a primary display region and displaying in a secondary display region remaining images other than the image displayed in the primary display region, wherein the image page includes the primary display region and the secondary display region, and a size of the primary display region is larger than a size of the secondary display region.

In some embodiments, the computer program, when read and executed by at least one processor of the computer device, causes the computer device to perform:
displaying a full-screen input page in response to detecting an input operation in the post-operation region, wherein the input page includes an input box, the image generation component, and a plurality of text sets corresponding to a plurality of types, and the plurality of types include at least two of a theme, an environment, or an action;
displaying target text in the input box in response to a determining instruction on the target text, wherein the target text is text in the text set corresponding to any one of the plurality of types; and
displaying on an image page the image set generated based on the target text in response to triggering the image generation component.

In some embodiments, the image set is generated based on the source comment information by an image generation model corresponding to the image generation component.

What is claimed is:

1. A method for processing comments, comprising:
displaying a post-operation region corresponding to a current resource, wherein the post-operation region is configured to post comment information and comprises an image generation component; and
displaying an image set in the post-operation region in response to triggering the image generation component in a case that the post-operation region comprises source comment information, wherein the image set is generated based on the source comment information.

2. The method according to claim 1, wherein said displaying the image set in the post-operation region in response to triggering the image generation component in the case that the post-operation region comprises the source comment information comprises:
changing the image generation component from a non-triggerable state to a triggerable state in a case that the source comment information meets a preset condition; and
displaying the image set in the post-operation region in response to triggering the image generation component in the triggerable state.

3. The method according to claim 2, wherein said changing the image generation component from the non-triggerable state to the triggerable state in the case that the source comment information meets the preset condition comprises one of:
changing the image generation component from the non-triggerable state to the triggerable state in a case that the source comment information is character comment information and a number of characters in the character comment information meets a preset number of characters;
changing the image generation component from the non-triggerable state to the triggerable state in a case that the source comment information is image comment information; or
changing the image generation component from the non-triggerable state to the triggerable state in a case that the source comment information comprises image comment information and character comment information.

4. The method according to claim 1, wherein said displaying the post-operation region corresponding to the current resource comprises:
displaying an information input region and an input operation region corresponding to the current resource; and
displaying the image generation component in the information input region and displaying a virtual keyboard panel in the input operation region; and
said displaying the image set in the post-operation region in response to triggering the image generation component in the case that the post-operation region comprises the source comment information comprises:
displaying the image set in the input operation region in response to triggering the image generation component in a case that the information input region displays the source comment information.

5. The method according to claim 4, wherein said displaying the image set in the input operation region in response to triggering the image generation component in the case that the information input region displays the source comment information comprises:
displaying an image panel in the input operation region in response to triggering the image generation component in a case that the source comment information displayed in the information input region comprises image comment information and character comment information, wherein the image panel comprises first generation information and second generation information; and
displaying on the image panel the image set generated based on the image comment information in response to triggering the first generation information; or displaying on the image panel the image set generated based on the character comment information in response to triggering the second generation information.

6. The method according to claim 1, further comprising:
displaying a first image as enlarged on the post-operation region in response to a preview instruction on the first image in the image set.

7. The method according to claim 6, wherein said displaying the first image as enlarged on the post-operation region comprises:
displaying the first image as enlarged and operation information for the first image on the post-operation region, wherein the operation information comprises at least one of regeneration information or “save to a preset storage region” information; and
generating, based on the source comment information, a second image for replacing the first image in response to triggering the regeneration information; or saving the first image to a preset storage region in response to triggering the “save to a preset storage region” information.

8. The method according to claim 1, wherein the post-operation region comprises an information input region and an input operation region, and said displaying the image set in the post-operation region further comprises:
displaying the image set in the input operation region;
displaying a target image in the information input region in response to a select operation on the target image in the image set, wherein the information input region comprises a posting component; and
displaying at least the target image on a comment display page in response to triggering the posting component.

9. The method according to claim 8, wherein said displaying at least the target image on the comment display page in response to triggering the posting component comprises:
displaying the target image and the source comment information on the comment display page in response to triggering the posting component.

10. The method according to claim 9, wherein said displaying the target image and the source comment information on the comment display page in response to triggering the posting component comprises:
in a case that the source comment information comprises image comment information, displaying the target image and the image comment information in a spliced form in response to triggering the posting component.

11. The method according to claim 9, further comprising:
displaying a function application link of the image generation component in a preset region corresponding to the target image on the comment display page, wherein
the function application link is configured to reserve an application of the image generation component or to apply the image generation component.

12. The method according to claim 1, wherein said displaying the image set in the post-operation region in response to triggering the image generation component in the case that the post-operation region comprises the source comment information comprises:
displaying the image set on a full-screen image page in response to triggering the image generation component in the case that the post-operation region comprises the source comment information, wherein the image set comprises images of at least two styles.

13. The method according to claim 12, wherein the source comment information comprises image comment information, the image set comprises the image comment information and images generated based on the image comment information, and said displaying the image set on the full-screen image page comprises:
displaying the images in the image set on the image page uniformly; or
displaying any image in the image set in a primary display region and displaying in a secondary display region remaining images other than the image displayed in the primary display region, wherein the image page comprises the primary display region and the secondary display region, and a size of the primary display region is larger than a size of the secondary display region.

14. The method according to claim 1, wherein said displaying the image set in the post-operation region in response to triggering the image generation component in the case that the post-operation region comprises the source comment information comprises:
displaying a full-screen input page in response to detecting an input operation in the post-operation region, wherein the input page comprises an input box, the image generation component, and a plurality of text sets corresponding to a plurality of types, and the plurality of types comprise at least two of a theme, an environment, or an action;
displaying target text in the input box in response to a determining instruction on the target text, wherein the target text is text in a text set of the plurality of text sets corresponding to any one of the plurality of types; and
displaying on an image page the image set generated based on the target text in response to triggering the image generation component.

15. The method according to claim 1, wherein the image set is generated based on the source comment information by an image generation model corresponding to the image generation component.

16. An electronic device, comprising:
a processor; and
a memory configured to store instructions that, when executed by the processor, cause the processor to:
display a post-operation region corresponding to a current resource, wherein the post-operation region is configured to post comment information and comprises an image generation component; and
display an image set in the post-operation region in response to triggering the image generation component in a case that the post-operation region comprises source comment information, wherein the image set is generated based on the source comment information.

17. The electronic device according to claim 16, wherein the instructions further cause the processor to:
change the image generation component from a non-triggerable state to a triggerable state in a case that the source comment information meets a preset condition; and
display the image set in the post-operation region in response to triggering the image generation component in the triggerable state.

18. The electronic device according to claim 16, wherein the instructions further cause the processor to:
display an information input region and an input operation region corresponding to the current resource;
display the image generation component in the information input region and displaying a virtual keyboard panel in the input operation region; and
display the image set in the input operation region in response to triggering the image generation component in a case that the information input region displays the source comment information.

19. The electronic device according to claim 16, wherein the post-operation region comprises an information input region and an input operation region, and wherein the instructions further cause the processor to:
display the image set in the input operation region;
display a target image in the information input region in response to a select operation on the target image in the image set, wherein the information input region comprises a posting component; and
display at least the target image on a comment display page in response to triggering the posting component.

20. A non-transitory computer-readable storage medium storing instructions that, when executed by a processor of an electronic device, cause the electronic device to:
display a post-operation region corresponding to a current resource, wherein the post-operation region is configured to post comment information and comprises an image generation component; and
display an image set in the post-operation region in response to triggering the image generation component in a case that the post-operation region comprises source comment information, wherein the image set is generated based on the source comment information.
